(19) United States
(12) Patent Application Publication
(10) Pub. No.: US 2006/0117964 A1
(43) Pub. Date: Jun. 8, 2006

(54) Method for generating a smoke

(76) Inventors: Sean Martin Cauchois, Queensland (AU); Martin Elliott Cauchois, Queensland (AU)

Correspondence Address: Smith, Gambrell & Russell, Suite 800, 1850 M Street, N.W., Wahington, DC, 20036, US

(21) Appl. No.: 10/953,467

(22) Filed: Sep. 30, 2004

(30) Foreign Application Priority Data
Jun. 18, 2004 (AU) AU 2004903316

(51) Int. Cl. A23B 4/044

(52) U.S. Cl. 99/482

(57) ABSTRACT

A method for generating smoke for use in treating food. Charcoal is heated to generate a gaseous stream containing particulate material. This gaseous stream is treated to remove particulate material therefrom and produce smoke suitable for contacting with food. The smoke is treated by passing it through filters, centrifuges, cyclones, or precipitators.

### FIELD OF THE INVENTION

The present invention relates to a method for generating a smoke for use in treating food. The present invention also provides a method for treating food by contacting the food with a smoke.

### BACKGROUND OF THE INVENTION

Smoking of foodstuff, particularly fish and meat products, has been practiced for an extremely long time. Indeed, ancient humans began using smoke to cure foodstuffs thousands of years ago.

Traditional smoking practices involved placing a foodstuff in a smoke room and passing natural smoke (e.g. burning wood) into the smoking room. The smoke acts to cure and preserve the foodstuff, whilst at the same time imparting a smoky flavour to the foodstuff. Traditional smoking practices also resulted in a substantial degree of dehydration of the smoked foodstuff.

More recent developments in smoking practices have utilised cold smoke to treat the food. When used to treat meat and fish, cold smoke keeps the meat and fish moist and succulent whilst preserving the meat and fish.

U.S. Pat. No. 5,484,619 in the name of Yamoaka describes a method for curing raw tuna meat by extra low temperature smoking. The method comprises the steps of burning a smoking material at 250 to 400° C. and passing the produced smoke through a filter to remove mainly tar therefrom, cooling the smoke passed through the filter in a cooling unit to between 0 and 5° C. whilst retaining ingredients exerting highly preservative and sterilising effects and smoking the tuna meat at extra low temperatures by exposure to the smoke cooled to between 0 and 5° C.

In Yamoaka, the smoke is generated by thermally decomposing wood in a smoke generating chamber. The smoke generating chamber allows for control of temperature and atmosphere during the smoke generation process. A temperature of 250 to 400° C. is used as, at these temperatures, the components of the wood decompose to produce a smoke that is effective for the sterilisation and prevention of decomposition and discolouration. The temperature is kept under 400° C. to avoid the formation of carcinogenic phenolic compounds and polycyclic aromatic hydrocarbons. Yamoaka describes the use of many kinds of wood to produce the smoke, such as oak, Japanese oak, peech, cherry, alder, Japanese linden, walnut, chestnut, white birch, hickory, poplar and plane.

The smoke removed from the smoke generating chamber of Yamoaka is then filtered to catch relatively large particles consisting mainly of tar. With the major part of the tar filtered off, the remaining smoke exerts preservative, sterilising and colour-keeping actions on substantially fresh fish and meat without imparting any disagreeable odour, taste or colour thereto. However, Yamoaka states that the smoke imparts agreeable taste and smell to the processed fish and meat while keeping them in a substantially fresh condition. Thus, the smoke generated in Yamoaka not only sterilises and preserves the meat and fish treated by the smoke, it also imparts a smoky flavour to the meat or fish. Indeed, Yamoaka, in describing the taste of tuna treated by the smoke, stated that the taste was a “tastiness unique to smoked products”.

U.S. Pat. No. 5,972,401, to Kowalski describes a tasteless, super-purified smoke that is manufactured to treat seafood and meat to preserve the freshness, colour, texture, and natural flavour, particularly after the food is frozen and thawed. The smoke is generated by burning an organic smoking material in a smoke generator. The smoke generator is described as including a natural gas or electric burner to combust wood sawdust packed into a multiple cylinder retort at temperatures in an operable range of 400 to 950 degrees Fahrenheit (204 to 510 degrees Centigrade) in an oxygen deprived apparatus.

The pyrolysis of the wood sawdust into smoke creates by-products of tar, moisture, and particulate residue at the outlet of the smoke generating subsystem. These by-products are collected in a liquid form in a tar/moisture/residue condensation chamber.

The smoke of Kowalski is next super-purified such that the phenols in both particulate and gaseous vapour phases are reduced to concentrations below recognition thresholds for odour and taste that impart a smoked flavour to the treated food. The smoke is most efficiently super-purified in Kowalski by flowing through a precipitation tower which washes and filters the smoke through ice and a combination of adsorbent and molecular sieve filters of cloth and activated carbon. The activated carbon filter effectively adsorbs phenols in the gaseous phase to concentrations below their odour and taste recognition thresholds. The molecular sieve cloth filters absorb gaseous vapour and particulate matter.

The super-refined smoke produced in Kowalski is substantially tasteless and can be used to directly flood a smoking treatment chamber. Alternatively, the smoke can be pumped into a storage chamber for short term storage of into a canister for long term storage.

### BRIEF DESCRIPTION OF THE INVENTION

The present inventors have now developed an alternative method for producing a smoke that can be used for treating food.

In a first aspect, the present invention provides a method for generating a smoke for use in treating food comprising heating charcoal to generate a gaseous stream containing particulate material and treating the gaseous stream to remove particulate material therefrom and produce a smoke suitable for contacting with food.

The smoke produced by the present invention is a refined smoke that does not impart a smoky flavour to foods treated by being brought into contact with smoke. Thus, the smoke acts to preserve the food without imparting a smoky taste to the food.

Preferably, the heating step in which charcoal is heated to generate the gaseous stream is conducted in a controlled atmosphere. More preferably, the heating step is conducted in an atmosphere having an enhanced concentration of carbon dioxide. Most suitably, the heating step is conducted in the presence of an atmosphere that comprises air and carbon dioxide.

Carbon dioxide is used in preferred embodiments of the heating step because the carbon dioxide acts as a fire retardant in the heating step, thereby avoiding or minimising combustion of the charcoal. Furthermore, carbon dioxide is an accepted sterile food processing aid.

The use of charcoal as a raw material in the heating step for generating the smoke provides the significant advantage that the gaseous stream (or smoke) produced by the heating step does not contain any significant level of flavour-imparting compounds or odour-imparting compounds present in a gaseous form. Some particulate material, such as soot, may be formed and the particulate material may impart flavours or odour to the smoke. However, such particulate material can be removed using simple physical separation processes. This should be contrasted with the prior art processes known to the present inventors, in which a smoke that contains flavour and odour imparting compounds in the gaseous form is produced, which smoke may subsequently be treated to remove those gaseous phase compounds therefrom, for example, by using adsorption with activated carbon or molecular sieves.

As mentioned above, the step of heating the charcoal produces a gas stream that may contain particulate material. The particulate material is largely in the form of soot particles. The gas stream is treated to remove those particles from the smoke prior to the smoke being sent to storage or being used to treat food.

The smoke may be treated by any known process to remove the particulate material therefrom. Suitably, the smoke is treated by passing it through one or more filters, by passing it through one or more centrifuges, by passing it through one or more cyclones, one or more precipitators such as electrostatic precipitators, or by passing through any other apparatus known to be suitable for removing particulate material from a gaseous stream.

The smoke that is produced by the process of the present invention is suitably cooled to a reduced temperature before it is either sent to storage or used to contact food. The smoke may be cooled by use of any suitable cooling process and apparatus.

After removal of the particulate material, the smoke may be sent to a storage vessel, such as a pressurised cylinder or other gas storage canister, or even an expandable bellows type storage arrangement.

Alternatively, the smoke may be directly sent to a food treatment facility in order to contact food with the smoke.

In one embodiment, the smoke is contacted with the food at a temperature that is between 0° C. and 4° C.

In a second aspect, the present invention provides a method for treating food comprising generating a smoke in accordance with the first aspect of the invention and contacting food with the smoke. The food may be selected from fish, beef, poultry, pork and certain vegetables (e.g. potatoes).

Preferably, the food is exposed to the smoke in a controlled chilled state, such that the temperature is always maintained below 4° C.

The smoke produced by the method of the present invention may also be used to treat food at higher temperatures, for example, by treating food in a traditional smoke house.

The present inventors have also found the enhanced smoking of food products may be obtained if the foods are placed on an open-cell foam during the smoking process. Accordingly, in a third aspect of the present invention provides a method for smoking a foodstuff by contacting the foodstuff with a smoke, characterised in that the foodstuff is placed on an open cell foam during the smoking step.

Without wishing to be bound by theory, the present inventors have postulated that placing the foodstuff on an open-cell foam during smoking is beneficial because:

a) liquid in the foodstuff can be removed from the foodstuff via the open cell foam, thereby avoiding the formation of pools around the foodstuff during smoking; and

b) the smoke can penetrate through the open cell foam (typically by diffusion) and thus come into contact with and treat the underneath surface of the foodstuff.

### BRIEF DESCRIPTION OF THE DRAWINGS

FIG. 1 is a flow sheet showing a process for producing smoke in accordance with a fist aspect of the present invention;

FIG. 2 is a flow sheet of an alternative embodiment for producing smoke in accordance with the method of the present invention; and

FIG. 3 is a schematic diagram showing a foodstuff being subjected to a smoking treatment whilst sitting on an open cell foam.

### DETAILED DESCRIPTION OF THE DRAWINGS

It will be appreciated that the attached drawings have been provided for the purpose of illustrating preferred embodiments of the present invention. Therefore, it is to be understood that the present invention escribes preferred embodiments and that the invention should not be considered to be limited solely to those preferred embodiments.

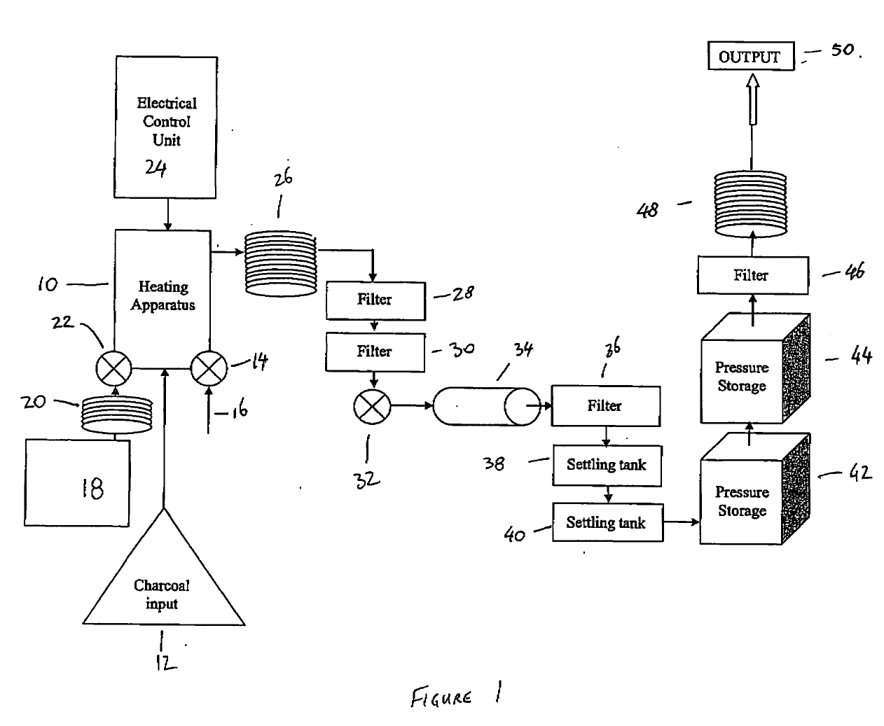

The process flow sheet shown in FIG. 1 includes a heating apparatus 10. The heating apparatus 10 may comprise a heating chamber lined with a refractory lining for insulation. The heating chamber may have a front opening door for loading charcoal. The heating chamber is suitably heated via convection from external electric heating coils. The heating chamber may include a shelf tray system that holds charcoal in the heating chamber.

It will be appreciated that the heating chamber may vary from the described heating chamber without departing from the scope of the present invention.

The heating chamber is used to heat charcoal. As shown in the process flow sheet of FIG. 1 charcoal 12 is positioned in the heating chamber. Specifically, the charcoal 12 is positioned in the heating chamber by opening the heating chamber door and placing the charcoal 12 onto the shelf tray system inside the heating chamber.

The heating apparatus 10 includes an air intake control valve 14 for controlling the flow of air 16 into heating apparatus 10. A source of carbon dioxide 18 is used to supply carbon dioxide to the heating apparatus 10. The carbon dioxide from source of carbon dioxide 18 passes through a carbon dioxide heating coil 20. Heating coil 20 is used to heat the carbon dioxide such that introduction of the carbon dioxide into the heating apparatus 10 does not adversely effect operation of the heating step. The heated carbon dioxide then passes through carbon dioxide control valve 22 and into the heating apparatus 10.

As mentioned above, in the embodiment shown in FIG. 1, the heating apparatus is heated by an electrical heating coil. In order to control the heating step, an electrical control unit 24 is operatively connected to the heating apparatus 10. The electrical control unit 24 controls the temperature inside the heating apparatus 10 to the desired heating temperature.

More preferably, the electrical control unit 24 also controls the amount of air admitted to the heating apparatus via line 16 and controls the amount of carbon dioxide admitted to the heating apparatus through carbon dioxide control valve 22. In this regard, the electrical control unit 24 may include automatic control over air intake control valve 14 and carbon dioxide control valve 22. The electrical control unit 24 may include one or more gas sensors to sense the composition of the atmosphere inside the heating apparatus 10 and/or to sense the composition of the smoke leaving the heating apparatus 10. The electrical control unit 24 may also include one or more temperature sensors to sense the temperature inside the heating apparatus 10 and temperature control means for controlling the temperature inside the heating apparatus 10, as required. A suitable control system could be easily prepared by a person skilled in the art and therefore further description of the control system for the heating apparatus need not be given.

One of the raw materials fed to the heating apparatus 10 is charcoal 12. Charcoal is the blackish residue obtained by removing water and other volatile constituents from animal and vegetable substances. The charcoal preferably used in the present invention comprises charcoal produced from wood. Charcoal produced from wood is typically made by heating wood in the absence of oxygen. This causes volatile products in the wood, such as methane, hydrogen, tars, phenols and some of the water to be removed. The charcoal residue remaining contains mainly carbon, with some water and traces of volatile chemicals and ash. Suitably, charcoal is the only “smoking material” that is present in the heating apparatus.

The charcoal is heated in heating apparatus 10 to a temperature that falls within the range of 100° C. to 1200° C. More preferably, the charcoal is heated to between 400° C. and 500° C. Air is admitted into the heating apparatus via air intake control valve 14 and carbon dioxide is admitted into the heating apparatus via carbon dioxide control valve 22. Carbon dioxide is added to act as a fire retardant inside the heating apparatus. The carbon dioxide is also an accepted sterile food processing aid and thus the smoke generated, which includes the added carbon dioxide, as well as other chemicals generated by heating the charcoal, does not include any additives that have not been approved for food processing.

The gaseous stream that is generated by heating the charcoal in heating apparatus 10 has, as its main components, nitrogen, carbon dioxide and carbon monoxide. Traces of water may also be present in the gaseous stream. The gaseous stream typically also includes particulate material, such as soot particles.

The gaseous stream generated in the heating apparatus suitably contains no gas phase compounds or compounds that impart flavour or odour to the smoke (or, if such gas phase compounds or components are present, they are present at levels below thresholds at which the smoke imparts flavour or odour to food treated by the smoke). The particulate material present in the gas stream may impart flavour or odour but the particulate material is not present as a gas-phase component.

The gaseous stream (or smoke) leaving heating apparatus 10 is initially cooled in cooling unit 26. Cooling unit 26 lowers the temperature of the gaseous stream to a temperature suitable for downstream processing of the gas stream. The cooling unit 26 may be any suitable cooling unit known to the person skilled in the art. The cooling unit may comprise a cooling coil having cooling water flowing therethrough, or it may comprise a refrigerated cooling apparatus or it may comprise a heat exchanger. Preferably, cooling unit 26 is an indirect cooling unit in which the gas stream does not come into direct contact with the cooling medium.

After leaving cooling unit 26, the cooled gaseous stream passes through filters 28, 30. Filters 28 and 30 act to remove particulate material from the gaseous stream. The filters 28, 30 suitably contain a filter medium that removes the particulate material but does not adsorb or remove any gaseous components contained in the gas stream. The filters 28, 30 suitably include a 1-micron polypropylene filter or a high efficiency particulate air filter (HEPA filter). Other filter mediums, such as sand filters, may also be used, if desired.

The flow of gas through filters 28, 30 is controlled by flow control valve 32.

The gas stream leaving filter 30 passes through flow control valve 32 and into pump or compressor 34. The pump or compressor 34 pressurises the gas stream and then passes the gas stream into filter 36, where further filtration of the gas stream takes place to remove any residual particulate material. Filter 36 is suitably arranged such that it removes finer material than filters 28 and 30. Indeed, each successive downstream filter in the flow sheet shown in FIG. 1 is preferably arranged such that it removes finer material than the next upstream filter. In this fashion, the particulate material is removed in stages, commencing with removal of the larger fractions followed by removal of successively finer fractions. In this fashion, efficient removal of the particulate material is achieved whilst avoiding rapid clogging of the filters.

The gas stream from filter 36 passes into settling tanks 38, 40. Settling tanks 38, 40 are provided to allow any particulate material that has managed to pass through the filters 28, 30 or 36 to settle and be removed from the gas stream. The settling tanks 38, 40 may also be provided with one or more water traps to remove any moisture remaining in the gas stream.

The gas stream is then passed to pressure storage units 42, 44. Pressure storage units 42, 44 may be provided for short term storage of the gas stream or for long term storage of the gas stream. Pressure storage units 42, 44 may comprise an expandable bellows or a gas cylinder or gas canister for containing compressed gas.

In a preferred embodiment of the present invention, the smoke produced by the method is contained at a storage pressure of between 70 and 115 psi.

Although the flow sheet of FIG. 1 shows two pressure storage units 42, 44, it will be appreciated that the pressure storage units may comprise a single pressure storage unit.

When it is decided to use the smoke to treat a food, the smoke is removed from the pressure storage unit 44, for example, by opening a control valve on a pressure storage cylinder. The smoke leaving pressure storage unit 44 may pass through a filter 46. The smoke is then cooled in cooling unit 48, desirably to a temperature between 0 and 4° C. The thus-cooled smoke is then contacted with food at 50.

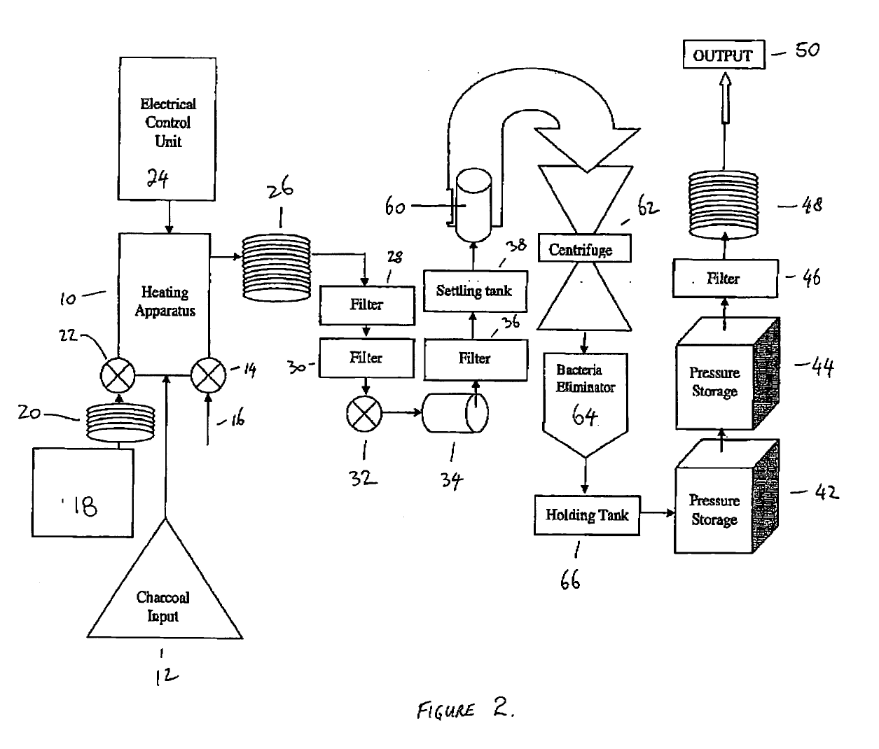

The flow sheet shown in FIG. 2 is a variation of the flow sheet shown in FIG. 1. For convenience, like parts have been given the same reference number. These parts will not be described further.

The flow sheet in FIG. 2 differs from that in FIG. 1 in that the smoke leaving settling tank 38 passes through pump 60 and thereafter into centrifuge 62. Centrifuge 62 is used to extract any remaining particulate material and any droplets of water. The thus-treated smoke passes to a bacteria eliminator 64, which kills or removes any bacteria in the smoke. The smoke then passes to holding tank 66 and thereafter into pressure storage vessels 42 and 44. The smoke may then be used in accordance with the description given for FIG. 1.

### EXAMPLE 1

An apparatus similar to that shown in FIG. 1 was used to generate a refined, flavourless smoke in accordance with the present invention. Approximately 10 kg of charcoal was placed on a charcoal basket having dimensions of 360 mm×360 mm×180 mm. The charcoal an charcoal basket were placed in a heating chamber having dimensions of 400 mm×400 mm×400 mm. Air and carbon dioxide were introduced into the chamber and the chamber was heated to 475° C. for a period of up to 10 hours. The carbon dioxide was introduced into the heating chamber at 20 Kpa and at approximately 10% by volume of the drawn off gas volume. The volumetric flow rate of carbon dioxide supplied to the heating chamber was estimated to be 1 litre/minute.

The smoke generated by this experiment was analysed and the composition of the smoke was as follows:

| Component | Typical (% by Vol) |
|---|---|
| Hydrogen | 10.9 |
| Oxygen | 2.0 |
| Nitrogen | 22.9 |
| Carbon Monoxide | 17.1 |
| Carbon Dioxide | 35.6 |

| | |
|---|---|
| Argon | 1.0 |
| Other components | Balance |

The break down of the “other components” was not analysed.

The process of the present invention is capable of producing a smoke having carbon monoxide levels of up to 40% by volume. However, it is preferred that the process produces a smoke having CO levels of from 14-20%, more preferably 14-18% by volume.

The atmosphere inside the heating chamber includes air and carbon dioxide. The air is preferably drawn in through a flow meter valve or pumped into the heating chamber. The air allows for the generation of the smoke from the charcoal.

Carbon dioxide is preferably added to the heating step to assist in maintaining a stable smoke generating environment. The carbon dioxide provides a buffer in case of flare up or increased oxygen content entering the heating chamber. The carbon dioxide stabilises the smoke generation step and also acts to extend the life of the charcoal being heated. Thus, of course, reduces charcoal consumption. It also regulates smoke generation and overcomes the tendency for smoke generation to peak shortly after heating of the charcoal commences, followed by a rapid decline, which tends to occur if only air is added to the heating chamber.

The smoke of the present invention is particularly suitable for use in treating food, particularly seafood. As the supply of seafood is not consistent with demand, it is necessary to freeze fish at the time it is abundant and to hold the fish in storage until demand occurs. In particular, winter is often a good time to catch fish yet the high demand for seafood typically occurs in summer.

Generally, red-fleshed fish such as tuna and striped marlin will alter their natural colour from a bright luminous colour to a dark brown appearance after freezing. Even white flesh fish changed from a white lustre to a flat dull grey colour after freezing.

The smoke produced in accordance with the present invention assists in retaining the natural colours of the flesh when the fish is thawed after the freezing process. The smoke may be considered to be an atmosphere for treating the fish. This atmosphere is generated by passing a controlled mixture of carbon dioxide and natural atmosphere over charcoal heated to temperatures, preferably above 400° C., and most preferably from 400 to 500° C. By controlling the volume of charcoal, carbon dioxide, amount of admitted air, heating time and heating temperature, the present invention is able to create an atmosphere that is drawn off and refined through various filters and cooling systems to remove moisture and particulate material. It may then be held in storage tanks for later use.

The refined smoke produced by the present invention is without tars and heavy particulate material. Fish, beef, poultry, pork and certain vegetables such as potatoes, may be exposed to this atmosphere in a controlled chilled state, such as below 4° C., for a period of time ranging from 12 to 48 hours. Shorter or longer exposure times may be used. This exposure prepares the food product for vacuum packaging and holding in a fresh chilled state for extended shelf life applications and/or freezing. The freezing process will change the colour of the food type. However, after thawing, the meats will resume their natural colour and freshness.

The process of the present invention produces a smoke that is suitable for treating food and yet does not impart a smoky flavour to the food. When the food is treated with the smoke at low temperatures, the food retains a natural and succulent appearance and yet the smoke still preserves the food and allows for an extended shelf life or an extended freezing life.

Unlike prior art methods, the smoke that is generated does not include any significant amounts of deleterious gaseous phase compounds that need to be removed by processes such as adsorption or absorption. The particulate material in the smoke may impart flavour or odour, but they are easily removed from the smoke. Separation of gaseous compounds is not required in the present invention. Thus, processing of the smoke is substantially simplified, moreover, the prior art processes entail risks that deleterious gas phase components could pass through the processing, for example, if adsorption canisters become loaded with adsorbed components. This risk is removed in the present invention because the generated smoke never contains significant amounts of such deleterious gas phase components.

The smoke produced by the present invention has been used to treat a wide range of fish species, including:

(Grouped Species are listed, not all individual market names are listed)

Snappers—Red, Goldband, Crimson, etc.

Gemfish—Rudderfish, Escolar, etc.

Trevallies—Yellowtail Kingfish, etc.

Salmons—Australian, Atlantic, King, Salmo Trouts etc.

Trouts—Coral etc.

Other fish species and other foodstuffs may also be treated by the smoke produced by the present invention.

To demonstrate the suitability of the smoke produced by the present invention, a number of fish fillets of different species were treated by the smoke and compared with untreated fillets. Comparisons were made with non-frozen smoked and unsmoked fillets and frozen smoked and unsmoked fillets.

The appearance of the fillets after 7 days was visually assessed and each fillet accorded a ranking on a scale of 1 to 5, with 1 being the lowest and equating to a least desirable appearance and 5 equating to a most desirable appearance. The results were as follows:

| WITHOUT flavourless refined smoke | WITH flavourless refined smoke |
|---|---|
| Snapper 1 | Snapper 5 |
| Gemfish 2 | Gemfish 4 |
| Trevallies 1 | Trevallies 5 |
| Salmons 3 | Salmons 4 |
| Trouts 3 | Trouts 4 |

The smoke produced in accordance with the present invention has also been used to “refresh” frozen fish, such as tunas, swordfish, tilapia and other species. In this case, frozen fillets were allowed to slightly thaw under controlled conditions and the fillets were then treated with the refined flavourless smoke. This resulted in a degree of colour and freshness to be retained by the fish fillet, which produced a more visually acceptable product.

The smoke can also be used to treat white fleshed fish as well as darker fleshed fish.

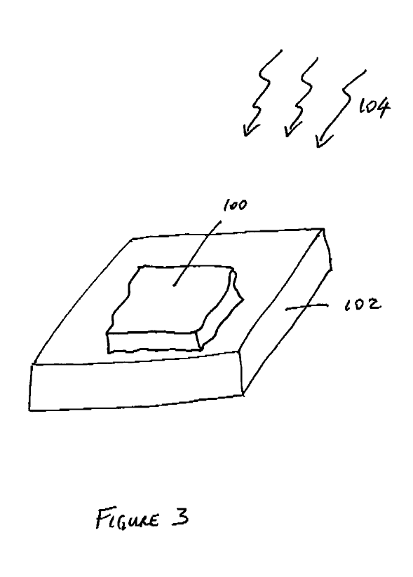

FIG. 3 shows a schematic diagram of a piece of fish 100 sitting on an open cell foam 102 during exposure to smoke 104 as part of a foodstuff treatment process. The present inventors have found that placing the foodstuff onto an open cell foam enhances or improves the smoking process. The use of open cell foam to support the foodstuff during the smoking process may be used in conjunction with the smoke generated in accordance with the present invention or it may be used in conventional or other smoking processes. The open cell foam may, for example, be purchased from Dymans Foams Australia and Hitachi Chemical Industries Co. Ltd, Japan and worldwide.

Those skilled in the art will appreciate that the invention described herein may be susceptible to variations and modifications other than those simply described. It is to be understood that the present invention encompasses all such variations and modifications that fall within its spirit and scope.

1. A method for generating a smoke for use in treating food comprising heating charcoal to generate a gaseous stream containing particulate material and treating the gaseous stream to remove particulate material therefrom and produce a smoke suitable for contacting with food.

2. A method as claimed in claim 1 wherein the heating step in which charcoal is heated to generate the gaseous stream is conducted in a controlled atmosphere.

3. A method as claimed in claim 2 wherein the heating step is conducted in an atmosphere having an enhanced concentration of carbon dioxide.

4. A method as claimed in claim 3 wherein the heating step is conducted in the presence of an atmosphere that comprises air and carbon dioxide.

5. A method as claimed in claim 1 wherein the smoke is treated by physically removing particulate therefrom.

6. A method as claimed in claim 1 wherein the smoke is treated by passing it through one or more filters, by passing it through one or more centrifuges, by passing it through one or more cyclones, one or more precipitators such as electrostatic precipitators, or by passing through any other apparatus known to be suitable for removing particulate material from a gaseous stream.

7. A method as claimed in claim 1 wherein the smoke that is produced is cooled to a reduced temperature before it is either sent to storage or used to contact food.

8. A method as claimed in claim 1 wherein, after removal of the particulate material, the smoke is sent to a storage vessel.

9. A method as claimed in claim 8 wherein the pressurised vessel is a pressurised cylinder or other gas storage canister, or even an expandable bellows type storage arrangement.

10. A method as claimed in claim 1 wherein the smoke is directly sent to a food treatment facility in order to contact food with the smoke.

11. A method for treating food comprising generating a smoke in accordance claim 1 and contacting food with the smoke.

12. A method as claimed in claim 11 wherein the food is exposed to the smoke in a controlled chilled state such that the temperature is always maintained below 4° C.

13. A method as claimed in claim 11 wherein the smoke is contacted with the food at a temperature that is between 0° C. and 4° C.

14. A method as claimed in claim 11 wherein the food is selected from fish, beef, poultry, pork and vegetables.

15. A method for smoking a foodstuff by contacting the foodstuff with a smoke, characterised in that the foodstuff is placed on an open cell foam during the smoking step.
